(19) United States
(12) Patent Application Publication
(10) Pub. No.: US 2016/0057652 A1
(43) Pub. Date: Feb. 25, 2016

(54) ENHANCED BACK-OFF TIMER SOLUTION FOR GTP-C OVERLOAD CONTROL

(71) Applicant: NOKIA SOLUTIONS AND NETWORKS OY, Espoo (FI)

(72) Inventors: Devaki CHANDRAMOULI, Plano, TX (US); Rainer LIEBHART, Munich (DE)

(21) Appl. No.: 14/781,446

(22) PCT Filed: Mar. 28, 2014
(86) PCT No.: PCT/EP2014/056264

§ 371 Date: Sep. 30, 2015

Related U.S. Application Data
(60) Provisional application No. 61/806,984, filed on Apr. 1, 2013.

(51) Int. Cl. H04W 28/02; H04L 12/841; H04L 12/803

(52) U.S. Cl. CPC H04W 28/0289; H04L 47/122; H04L 47/28

(57) ABSTRACT

A system, a method, an apparatus, and a computer program product for general packet radio service (GPRS) tunneling protocol control plane (GTP-C) overload control is provided. One method includes sending a message indicating overload to a network entity. The message may comprise a back-off time value to indicate the overload. The method may further include selectively reducing signaling based on the message.

### CROSS-REFERENCE TO RELATED APPLICATIONS

This application claims priority to U.S. Provisional Application No. 61/806,984, filed on Apr. 1, 2013. The entire contents of this earlier filed application are hereby incorporated by reference in its entirety.

### BACKGROUND

1. Field

Embodiments of the invention generally relate to wireless communications networks, such as the Universal Mobile Telecommunications System (UMTS) Terrestrial Radio Access Network (UTRAN) Long Term Evolution (LTE) and Evolved UTRAN (E-UTRAN).

2. Description of the Related Art

Universal Mobile Telecommunications System (UMTS) Terrestrial Radio Access Network (UTRAN) refers to a communications network including base stations, or Node-Bs, and radio network controllers (RNC). UTRAN allows for connectivity between the user equipment (UE) and the core network. The RNC provides control functionalities for one or more Node Bs. The RNC and its corresponding Node Bs are called the Radio Network Subsystem (RNS).

Long Term Evolution (LTE) refers to improvements of the UMTS through improved efficiency and services, lower costs, and use of new spectrum opportunities. In particular, LTE is a 3rd Generation Partnership Project (3GPP) standard that provides for uplink peak rates of at least 50 megabits per second (Mbps) and downlink peak rates of at least 100 Mbps. LTE supports scalable carrier bandwidths from 20 MHz down to 1.4 MHz and supports both Frequency Division Duplexing (FDD) and Time Division Duplexing (TDD).

As mentioned above, LTE improves spectral efficiency in communication networks, allowing carriers to provide more data and voice services over a given bandwidth. Therefore, LTE is designed to fulfill future needs for high-speed data and media transport in addition to high-capacity voice support. Advantages of LTE include high throughput, low latency, FDD and TDD support in the same platform, an improved end-user experience, and a simple architecture resulting in low operating costs. In addition, LTE is an all internet protocol (IP) based network, supporting both IPv4 and IPv6.

The Evolved 3GPP Packet Switched Domain, which is also known as the Evolved Packet System (EPS), provides IP connectivity using the E-UTRAN.

### SUMMARY

One embodiment is directed to a method including sending a message indicating overload to a network entity. The message may comprise a back-off time value to indicate the overload. The method may then include selectively reducing signaling based on the message.

Another embodiment is directed to an apparatus including at least one processor and at least one memory including computer program code. The at least one memory and the computer program code are configured, with the at least one processor, to cause the apparatus at least to send a message indicating overload to a network entity. The message may comprise a back-off time value to indicate the overload. The at least one memory and the computer program code may then be configured, with the at least one processor, to cause the apparatus at least to selectively reduce signaling based on the message.

Another embodiment is directed to an apparatus including means for sending a message indicating overload to a network entity. The message may comprise a back-off time value to indicate the overload. The apparatus may then include means for selectively reducing signaling based on the message.

Another embodiment is directed to a computer program embodied on a computer readable medium. The computer program, when executed by a computer, may be configured to control a processor to perform a method including sending a message indicating overload to a network entity. The message may comprise a back-off time value to indicate the overload. The method may then include selectively reducing signaling based on the message.

Another embodiment is directed to a method including receiving a message indicating overload at a network entity. The message may comprise a back-off time value to indicate the overload. The method may then include selectively reducing signaling based on the message.

Another embodiment is directed to an apparatus including at least one processor and at least one memory including computer program code. The at least one memory and the computer program code are configured, with the at least one processor, to cause the apparatus at least to receive a message indicating overload at a network entity. The message may comprise a back-off time value to indicate the overload. The at least one memory and the computer program code may then be configured, with the at least one processor, to cause the apparatus at least to selectively reduce signaling based on the message.

Another embodiment is directed to an apparatus including means for receiving a message indicating overload at a network entity. The message may comprise a back-off time value to indicate the overload. The apparatus may also include means for selectively reducing signaling based on the message.

Another embodiment is directed to a computer program embodied on a computer readable medium. The computer program, when executed by a computer, may be configured to control a processor to perform a method including receiving a message indicating overload at a network entity. The message may comprise a back-off time value to indicate the overload. The method may then include selectively reducing signaling based on the message.

### BRIEF DESCRIPTION OF THE DRAWINGS

For proper understanding of the invention, reference should be made to the accompanying drawings, wherein:

FIG. 1 illustrates a system, according to one embodiment;

FIG. 2a illustrates an apparatus, according to an embodiment;

FIG. 2b illustrates an apparatus, according to another embodiment;

FIG. 3a illustrates a flow diagram of a method, according to one embodiment; and

FIG. 3b illustrates a flow diagram of a method, according to another embodiment.

### DETAILED DESCRIPTION

It will be readily understood that the components of the invention, as generally described and illustrated in the figures herein, may be arranged and designed in a wide variety of different configurations. Thus, the following detailed description of the embodiments of a system, a method, an apparatus, and a computer program product for general packet radio service (GPRS) tunneling protocol control plane (GTP-C) overload control, as represented in the attached figures, is not intended to limit the scope of the invention, but is merely representative of selected embodiments of the invention.

If desired, the different functions discussed below may be performed in a different order and/or concurrently with each other. Furthermore, if desired, one or more of the described functions may be optional or may be combined. As such, the following description should be considered as merely illustrative of the principles, teachings and embodiments of this invention, and not in limitation thereof.

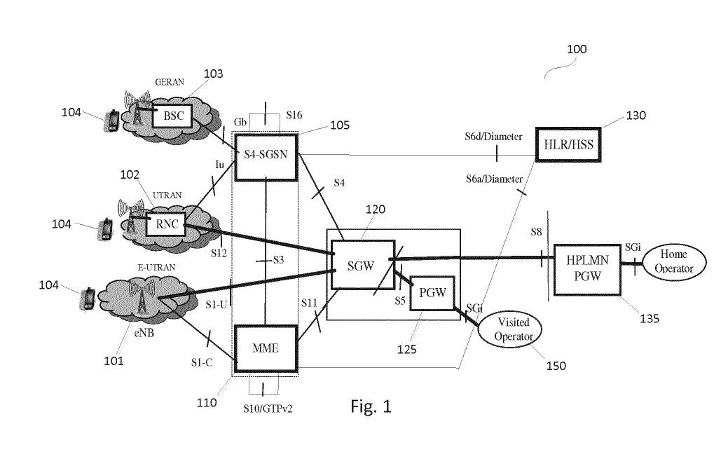

The evolved packet system (EPS) is the evolution of the general packet radio system (GPRS). EPS provides a new radio interface and new evolved packet core (EPC) network functions for broadband wireless data access. FIG. 1 illustrates an example of the EPS core network 100, according to an embodiment. As illustrated in FIG. 1, the EPS core network 100 may include the Mobility Management Entity (MME) 110, Packet Data Network Gateway (PGW) 125, and Serving Gateway (SGW) 120. MME 110 may be connected to SGW 120 via the S1 interface, and the SGW 120 in turn may be connected to PGW 125 via the S5 interface.

A common packet domain core network, such as EPS core network 100, can be used to provide core network functionality to the base station controller (BSC) 103 of the GSM/Edge radio access network (GERAN), the radio network controller (RNC) 102 of the UTRAN, and the eNodeB (eNB) 101 of the E-UTRAN.

MME 110 may be considered the main control node for the core network 100. Some features handled by MME 110 include: bearer activation/de-activation, idle mode UE tracking, choice of SGW for a UE 104, intra-LTE handover involving core network node location, interacting with the home location register (HLR)/home subscriber server (HSS) 130 to authenticate user on attachment, and providing temporary identities for UEs 104.

HLR/HSS 130 is a central database that contains user-related and subscription-related information. Functions of the HLR/HSS 130 may include mobility management, call and session establishment support, user authentication and access authorization.

SGW 120 is a data plane element within the core network 100. SGW 120 manages user plane mobility and acts as the main interface between the radio access network(s) and the core network. SGW 120 can also maintain the data path between the eNBs 101 and PGW 125. As a result, SGW 120 may form an interface for the data packet network at the E-UTRAN. SGW 120 may also be in communication with home public land mobile network (HPLMN) gateway 135 which may store the home user's 140 subscription data. PGW 125 provides connectivity for the UE to external packet data networks (PDNs). A UE 104 may have connectivity with more than one PGW 125 for accessing multiple PDNs 150.

A serving GPRS support node (SGSN) 105 may be provided in the core network 100 to transfer information to and from the GERAN and UTRAN via an lu interface, for example. SGSN 105 may communicate with SGW 120 via, for example, the S4 interface. SGSN 105 may store location information for a UE, such as current cell, and may also store user profiles, such as international mobile subscriber identity (IMSI).

The 3rd generation partnership project (3GPP) SA2 is working on core network overload control for GTP-C due to signaling issues faced in operators' networks and in order to improve network resiliency. The following are some use cases that have been discussed as possible reasons for overload:
1. Frequent Idle→Connected, and Connected→Idle transitions caused due, for example, to eNB idle timer setting. Depending on the value of eNB idle timers (which may result in large number of SERVICE REQUESTs from UEs in a busy hour, for example), session overload may occur in either one SGW managing tracking areas (TA/TAs) or a set of SGWs.
2. Large number of users performing tracking area update (TAU)/routing area update (RAU). In a typical network deployment, the number of MMEs and SGWs is considerably larger than the number of PGWs. In densely populated areas, such as the north eastern part of the U.S. including metro New York, metro Boston, metro Philadelphia, etc., mass transit systems transfer a large number of users on a daily basis. This results in a large number of simultaneous TAUs/RAUs towards MMEs/SGSNs and corresponding Modify Bearer Requests towards SGWs. This may result in a large number of Modify Bearer Request (MBR) messages towards a single or very few PGWs.
3. At the failure of an EPC node (e.g., SGW) where the network would try to re-establish the GTP-C session via a new EPC node (e.g., SGW) that would replace the failing one. The risk is that the failure of a node (e.g., SGW) would trigger a spike in GTP-C signaling to restore within the shortest time the PDN connections affected by the failure.

At overload or failure of a GTP-C node (e.g., SGW), the network may need to establish subsequent (new) GTP-C sessions via a smaller number of GTP-C nodes (e.g., using only other SGW of the same cluster). The risk is that the overload/failure of a node (e.g., SGW) would trigger an increase of GTP-C signaling that would overload other nodes (e.g., other SGWs of the same cluster). Thus, there is a need for a solution to perform proactive overload control that can complement existing (e.g., domain name system (DNS) based selection) mechanisms and admission control procedures with minimal standardization impact, thus reducing complexity for implementation.

One existing solution that has been considered to address the overload issues noted above includes access point name (APN) specific back-off timers. A concern with this solution is that the existing APN congestion control mechanism can be seen as an on/off mechanism when approaching congestion or during congestion of a specific APN. In addition, APN specific back-off is applicable only to new Create Session Requests, but not to other messages. This mechanism may introduce oscillations in the network with spikes of traffic when the APN back-off timer expires in MMEs/SGSNs. Furthermore, this solution does not address PGW overload when the whole node is overloaded or the interface is congested.

Another drawback with the existing APN based congestion control feature is that there is no way for the PGW to indicate congestion stop, or override or reset the back-off timer when APN congestion has been alleviated before the originally provided back-off timer expired in the MME. The reason is that the timer is included only in Create session response messages which are only sent as a response to Create session request messages. However, the MME is not allowed to send Create session request messages when back-off timer is running in the MME.

Another proposed solution is to notify PGW load information to the MME. This solution proposes to send a load level together with additional data from the PGW to the SGW and the MME so that these nodes, depending on the load level, can take certain actions, such as to reject a certain percentage of messages. Since DNS servers and load balancers deployed in the networks can be notified of load information, distributing PGW load information to serving nodes will be duplicating the information in multiple network elements. Furthermore, this could impact node selection algorithms, if the load information available in the MME contradicts the load information available in the load balancer (i.e., they are updated at different times). This solution introduces complexity to GTP-C interfaces, requires additional standardization, and complex implementation.

Another proposed solution introduces an enhanced load balancer function. In particular, this solution introduces a new function, and 2 new interfaces (Load Balancer->MME, Load Balancer->S-GW/P-GW) if this needs to be deployed in a multi-vendor environment. Furthermore, this cannot be used as a solution for proactive overload control.

In view of the various issues noted above, embodiments of the present invention provide an “enhanced back-off timer solution” to address proactive overload control and at the same time allowing this feature to be used for “reactive overload control.” Further, embodiments of the invention do not require the PGW and SGW to provide load and other information to the MME. For example, embodiments introduce the capability for the SGW/PGW to adjust (override) originally provided “back-off timer(s)” based on current load factor without actually sending the load information to the MME thus giving it the flexibility to adjust incoming traffic from upstream nodes and the capability to stop the timer when overload has been alleviated.

One embodiment is configured to use a back-off timer to allow overload control with a granularity of a node instead of just a single or several APNs. This embodiment allows the PGW (towards SGW/MME) or SGW (towards MME) to indicate whether the back-off time in create session response messages is applicable for a specific APN or for the whole node. Thus, according to this embodiment, the MME/SGW can distinguish between: 1. APN specific congestion; or 2. Nodal overload, where all APN(s) are backed-off.

In case of a low load level the PGW (or S-GW) can send, for example, a low back-off time value to the connected SGWs/MMEs, while increasing the back-off time once the P-GW internal load level increases.

According to one embodiment, PGW can provide different back-off time values to different SGWs/MMEs and MMEs can provide different back-off time values to different UEs in order to avoid the situation where deferred requests are synchronized leading to traffic spikes. This will also avoid oscillations in the network when the back-off timers expire in UEs and SGWs/MMEs.

In an embodiment, for instance, the indication of the back-off time value(s) can be accomplished by including a scope information element (IE) or modifying the cause information element (IE) sent along with the PGW back-off time in the create session response message. Similarly, according to one embodiment, the SGW can indicate nodal overload by including a SGW back-off time in the create session response message sent to the MME.

According to certain embodiments, some possible MME actions when it receives a back-off time per PGW and manages back-off time per PGW, include: the MME may stop sending signaling messages towards the PGW and, thus, rejects all session management requests; and/or the MME may not select the corresponding PGW for new connection requests.

According to certain embodiments, some possible MME actions when it receives a back-off time per SGW and manages back-off timer per SGW, include: the MME may stop sending signaling messages towards SGW and, thus, it may perform SGW relocation for existing connections; and/or the MME may not select the corresponding S-GW for new connection requests.

One of the drawbacks with the conventional APN congestion control feature specified in 3GPP Release 10 is that there is not a mechanism for the PGW or SGW to indicate overload stop or to reset the back-off time when congestion has been alleviated (both for “APN specific overload” and “nodal overload” in the P-GW) before the originally provided back-off timer elapses in the MME. This is because, in the conventional APN back-off timer feature, the timer is included only in create session response messages which are sent only as a response to create session request messages, but the MME is not allowed to send create session request messages when the back-off timer is running in the MME.

Certain embodiments of the present invention provide several possible solutions that can be utilized to address this drawback. In one embodiment, for example, the PGW is configured to indicate selective reduction in signaling while indicating overload as part of the scope or cause IE mentioned above. This embodiment allows for selective signaling, and for selective signaling when PGW has backed off connection requests due to APN specific back-off or nodal overload. In this embodiment, the MME may be configured to manage back-off timer per APN/PGW (as indicated), and the MME can selectively reduce signaling for a certain APN or towards a certain PGW. Some possible MME actions according to this embodiment include: reject session management requests from low priority UE(s); reduce user location information (ULI) signaling; and/or reject selective session management requests from UE(s). This embodiment will still allow the MME to selectively send create session requests towards the PGW. Thus, this embodiment allows the PGW to reset and update the originally provided back-off time value in subsequent create session response messages.

In another embodiment, the PGW initiated requests are configured to include updated back-off time values. This embodiment will also allow the PGW to indicate that overload has been alleviated and, therefore, will help reset or override the originally provided back-off time values to the MME. Alternatively, the MME can use PGW initiated requests and/or PGW initiated requests for a certain APN as an indication that overload has been alleviated for the node and/or the corresponding APN.

In another embodiment, the PGW is configured to indicate updated back-off time values in other GTP-C response messages (e.g., modify bearer response) that are exchanged for existing PDN connections. This embodiment will also allow the PGW to indicate that overload has been alleviated and, therefore, will help reset or override the originally provided back-off time values to the MME.

In another embodiment, the PGW is configured to send a new GTP-C message (e.g., Overload Stop, Overload Reset) immediately after the overload is alleviated. This embodiment will help stop or reset the back-off timer(s) stored in the MME.

According to another embodiment, updated back-off timer values may be sent in GTP management messages, such as in an Echo Response from the PGW to SGW/MME.

Furthermore, similar solution options can be applied for the SGW to update the originally issued back-off timer to the MME. However, for SGW, “APN specific back-off” does not apply.

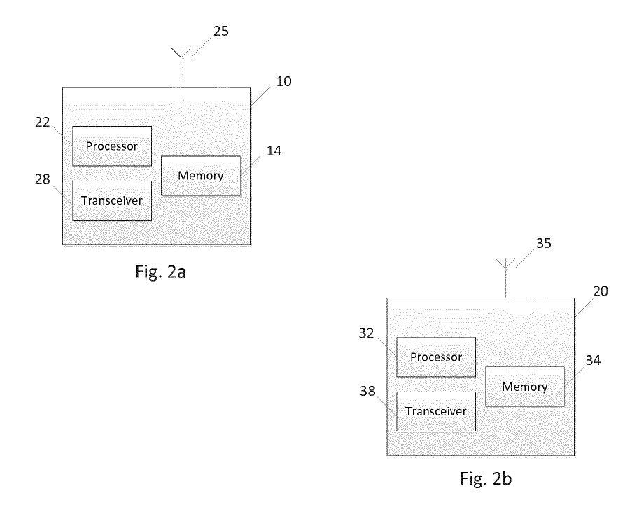

FIG. 2a illustrates an example of an apparatus 10 according to an embodiment. In one embodiment, apparatus 10 may be a gateway (e.g., PGW or SGW). It should be noted that one of ordinary skill in the art would understand that apparatus 10 may include components or features not shown in FIG. 2a.

As illustrated in FIG. 2a, apparatus 10 includes a processor 22 for processing information and executing instructions or operations. Processor 22 may be any type of general or specific purpose processor. While a single processor 22 is shown in FIG. 2a, multiple processors may be utilized according to other embodiments. In fact, processor 22 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 10 further includes a memory 14, which may be coupled to processor 22, for storing information and instructions that may be executed by processor 22. Memory 14 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 14 can be comprised of any combination of random access memory (RAM), read only memory (ROM), static storage such as a magnetic or optical disk, or any other type of non-transitory machine or computer readable media. The instructions stored in memory 14 may include program instructions or computer program code that, when executed by processor 22, enable the apparatus 10 to perform tasks as described herein.

Apparatus 10 may also include one or more antennas 25 for transmitting and receiving signals and/or data to and from apparatus 10. Apparatus 10 may further include a transceiver 28 configured to transmit and receive information. For instance, transceiver 28 may be configured to modulate information on to a carrier waveform for transmission by the antenna(s) 25 and demodulates information received via the antenna(s) 25 for further processing by other elements of apparatus 10. In other embodiments, transceiver 28 may be capable of transmitting and receiving signals or data directly.

Processor 22 may perform functions associated with the operation of apparatus 10 including, without limitation, precoding of antenna gain/phase parameters, encoding and decoding of individual bits forming a communication message, formatting of information, and overall control of the apparatus 10, including processes related to management of communication resources.

In an embodiment, memory 14 stores software modules that provide functionality when executed by processor 22. The modules may include, for example, an operating system that provides operating system functionality for apparatus 10. The memory may also store one or more functional modules, such as an application or program, to provide additional functionality for apparatus 10. The components of apparatus 10 may be implemented in hardware, or as any suitable combination of hardware and software.

As mentioned above, according to one embodiment, apparatus 10 may be a gateway, such as a PGW or SGW, for example. In an embodiment, apparatus 10 may be controlled by memory 14 and processor 22 to send a message configured to indicate overload by including a back-off time value to a network entity, such as a MME. The back-off time value included in the message may be indicated as being applicable to a single APN (i.e., APN specific back-off) or indicated as being a back-off time applicable to all APNs. In an embodiment, the message may be a create session response message that includes a cause IE or scope IE along with the back-off timer. According to one embodiment, the cause IE or scope IE may include an indication of selective reduction in signaling. The indication of selective reduction in signaling may include an APN specific back-off selective signaling and/or a nodal overload selective signaling.

According to some embodiments, apparatus 10 may be controlled by memory 14 and processor 22 to indicate updated back-off timer values, for example, in the create session response message, in other GTP-C response messages (e.g., modify bearer response), and/or in GTP management messages (e.g., echo response from PGW to SGW/MME). In another embodiment, apparatus 10 may be controlled by memory 14 and processor 22 to send a new GTP-C message (e.g., overload stop or overload reset) immediately after the overload is eased or alleviated.

FIG. 2b illustrates an example of an apparatus 20 according to another embodiment. In an embodiment, apparatus 20 may be a network entity, such as a MME. It should be noted that one of ordinary skill in the art would understand that apparatus 20 may include components or features not shown in FIG. 2b.

As illustrated in FIG. 2b, apparatus 20 includes a processor 32 for processing information and executing instructions or operations. Processor 32 may be any type of general or specific purpose processor. While a single processor 32 is shown in FIG. 2b, multiple processors may be utilized according to other embodiments. In fact, processor 32 may include one or more of general-purpose computers, special purpose computers, microprocessors, digital signal processors (DSPs), field-programmable gate arrays (FPGAs), application-specific integrated circuits (ASICs), and processors based on a multi-core processor architecture, as examples.

Apparatus 20 further includes a memory 34, which may be coupled to processor 32, for storing information and instructions that may be executed by processor 32. Memory 34 may be one or more memories and of any type suitable to the local application environment, and may be implemented using any suitable volatile or nonvolatile data storage technology such as a semiconductor-based memory device, a magnetic memory device and system, an optical memory device and system, fixed memory, and removable memory. For example, memory 34 can be comprised of any combination of random access memory (RAM), read only memory (ROM), static storage such as a magnetic or optical disk, or any other type of non-transitory machine or computer readable media. The instructions stored in memory 34 may include program instructions or computer program code that, when executed by processor 32, enable the apparatus 20 to perform tasks as described herein.

Apparatus 20 may also include one or more antennas 35 for transmitting and receiving signals and/or data to and from apparatus 20. Apparatus 20 may further include a transceiver 38 configured to transmit and receive information. For instance, transceiver 38 may be configured to modulate information on to a carrier waveform for transmission by the antenna(s) 35 and demodulates information received via the antenna(s) 35 for further processing by other elements of apparatus 20. In other embodiments, transceiver 38 may be capable of transmitting and receiving signals or data directly.

Processor 32 may perform functions associated with the operation of apparatus 20 including, without limitation, precoding of antenna gain/phase parameters, encoding and decoding of individual bits forming a communication message, formatting of information, and overall control of the apparatus 20, including processes related to management of communication resources.

In an embodiment, memory 34 stores software modules that provide functionality when executed by processor 32. The modules may include, for example, an operating system that provides operating system functionality for apparatus 20. The memory may also store one or more functional modules, such as an application or program, to provide additional functionality for apparatus 20. The components of apparatus 20 may be implemented in hardware, or as any suitable combination of hardware and software.

As mentioned above, according to one embodiment, apparatus 20 may be a network entity, such as a MME. In this embodiment, apparatus 20 may be controlled by memory 34 and processor 32 to receive a message configured to indicate overload by including a back-off time value from a gateway, such as a PGW or SGW. The back-off time value included in the message may be indicated as being applicable to a single APN (i.e., APN specific back-off) or indicated as being a back-off time applicable to all APNs.

In an embodiment, the message may be a create session response message that includes a scope IE along with the back-off timer. According to one embodiment, the scope IE may include an indication of selective reduction in signaling. The indication of selective reduction in signaling may include an APN specific back-off selective signaling and/or a nodal overload selective signaling.

In an embodiment, in response to receiving the message indicating overload from the gateway, apparatus 20 may be controlled by memory 34 and processor 32 to stop sending signaling messages towards the gateway (e.g., PGW or SGW) and reject all session management requests. According to one embodiment, apparatus 20 may be further controlled by memory 34 and processor 32 to not select the gateway for new connection requests.

According to some embodiments, when the message includes an indication of selective reduction in signaling, apparatus 20 is configured to selectively reduce signaling for a certain APN and/or towards the gateway. For example, apparatus 20 may be controlled by memory 34 and processor 32 to reject session management requests from low priority UE(s), to reduce ULI signaling, and/or to reject selective session management requests from UEs.

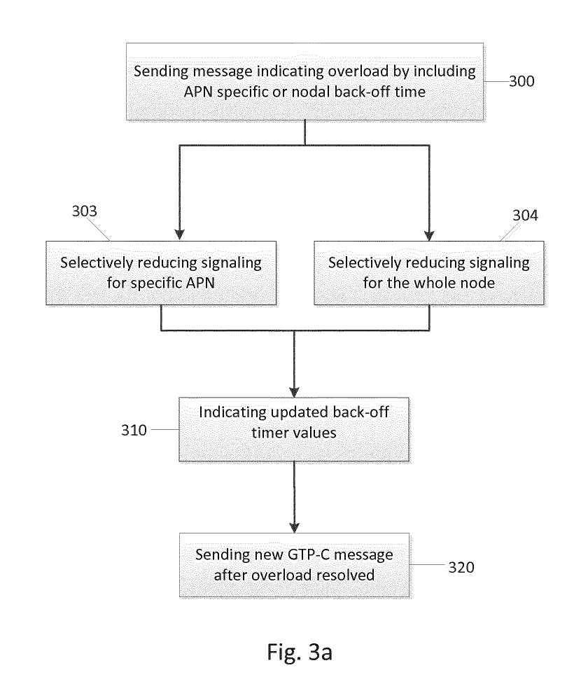

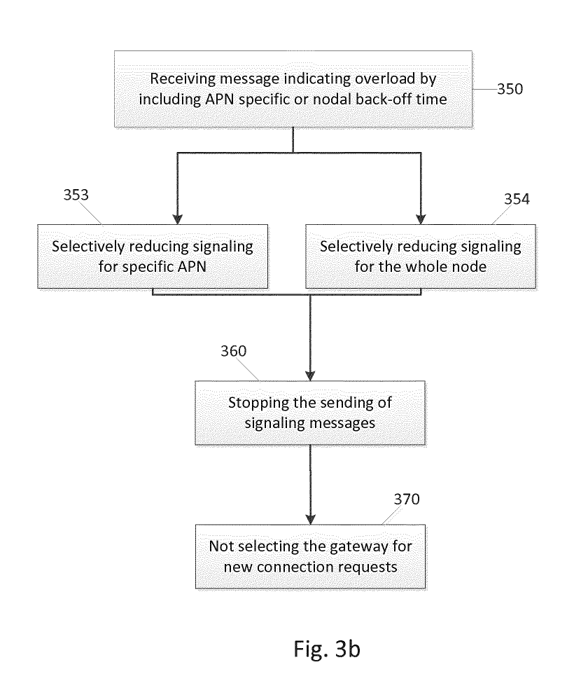

FIG. 3a illustrates an example of a flow diagram of a method, according to one embodiment. In an embodiment, the method of FIG. 3a may be performed by a gateway (e.g., PGW or SGW). The method may include, at 300, sending a message indicating overload by including a back-off time value to a network entity, such as a MME. The back-off time value included in the message may be indicated as being applicable to a single APN (i.e., APN specific back-off) or nodal overload, indicated as being a back-off time applicable to all APNs. In an embodiment, the message may be a create session response message that includes a cause IE or scope IE along with the back-off timer. According to one embodiment, the cause IE or scope IE may include an indication of selective reduction in signaling. The indication of selective reduction in signaling may include an APN specific back-off selective signaling and/or a nodal overload selective signaling. Accordingly, if the back-off time included in the message is indicated being applicable to a single APN, then the method may include, at 303, selectively reducing signaling for the specific APN indicated in the message. If the back-off time included in the message is a nodal back-off time, then the method may include, at 304, selectively reducing signaling for the whole node.

According to some embodiments, the method may further include, at 310, indicating updated back-off timer values, for example, in the create session response message, in other GTP-C response messages (e.g., modify bearer response), and/or in GTP management messages (e.g., echo response from PGW to SGW/MME). In another embodiment, the method may also include, at 320, sending a new GTP-C message (e.g., overload reset) immediately after the overload is resolved.

FIG. 3b illustrates an example of a flow diagram of a method, according to one embodiment. In an embodiment, the method of FIG. 3b may be performed by a network entity, such as a MME. The method may include, at 350, receiving a message indicating overload by including a back-off time value from a gateway, such as a PGW or SGW. The back-off time value included in the message may be indicated as being applicable to a single APN (i.e., APN specific back-off) or indicated as being a nodal back-off time (e.g., all APN back-off). In an embodiment, the message may be a create session response message that includes a cause IE or scope IE along with the back-off timer. According to one embodiment, the cause IE or scope IE may include an indication of selective reduction in signaling. The indication of selective reduction in signaling may include an APN specific back-off selective signaling and/or a nodal overload selective signaling. Accordingly, if the back-off time included in the message is indicated being applicable to a single APN, then the method may include, at 353, selectively reducing signaling for the specific APN indicated in the message. If the back-off time included in the message is a nodal back-off time, then the method may include, at 354, selectively reducing signaling for the whole node.

In an embodiment, in response to receiving the message indicating overload from the gateway, the method may further include, at 360, stopping the sending of signaling messages towards the gateway (e.g., PGW or SGW) and rejecting all session management requests. According to one embodiment, the method may further include, at 370, not selecting the gateway for new connection requests.

According to some embodiments, when the message includes an indication of selective reduction in signaling, the method may further include selectively reducing signaling for a certain APN and/or towards the gateway. For example, the method may include rejecting session management requests from low priority UE(s), reducing ULI signaling, and/or rejecting selective session management requests from UEs.

In some embodiments, the functionality of any of the methods described herein, such as those illustrated in FIGS. 3a and 3b discussed above, may be implemented by software and/or computer program code stored in memory or other computer readable or tangible media, and executed by a processor. In other embodiments, the functionality may be performed by hardware, for example through the use of an application specific integrated circuit (ASIC), a programmable gate array (PGA), a field programmable gate array (FPGA), or any other combination of hardware and software.

One of the benefits of the embodiments described herein is that they allow for the support of proactive overload control both on an APN level and nodal level with minor enhancements to existing procedures. For example, certain embodiments do not require the PGW to indicate actual load or other information to MME. Thus, there is no contradiction in the load information available in different network elements. In addition, embodiments allow for maximum re-use of existing solution(s), thus minimizing standardization and implementation impact. For instance, some embodiments require only the addition of one new IE or one new message. In addition, certain embodiments allow for proactive control of APN overload and nodal overload control in operator's network. Embodiments can serve as a complementary solution to existing DNS based load balancing and admission control to ensure a robust system and load balanced SGW(s)/PGW(s). Also, embodiments can be similarly applied for all other GTP-C interfaces. Further, embodiments can also be implemented for E-UTRAN, UTRAN and GERAN.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. A method, comprising:
sending a message indicating overload to a network entity, wherein the message comprises a back-off time value to indicate the overload; and
selectively reducing signaling based on the message.

2. The method according to claim 1, wherein the back-off time value is indicated as being applicable to a single access point name (APN) or is a nodal back-off time applicable to all access point names (APNs).

3. The method according to claim 1, wherein the message is a create session response message comprising a cause information element (IE) or scope information element (IE) along with the back-off time value.

4. The method according to claim 3, wherein the cause information element (IE) or the scope information element (IE) comprises an indication of selective reduction in signaling.

5. The method according to claim 4, wherein the indication of selective reduction in signaling comprises an access point name (APN) specific back-off selective signaling and/or a nodal overload selective signaling.

6. The method according to claim 1, wherein, when the back-off time included in the message is indicated as being applicable to a single access point name (APN), the selectively reducing further comprises selectively reducing signaling for the specific access point name (APN) indicated in the message.

7. The method according to claim 1, wherein, when the back-off time included in the message is a nodal back-off time, the selectively reducing further comprises selectively reducing signaling for the whole node.

8. An apparatus, comprising:
at least one processor; and
at least one memory including computer program code,
wherein the at least one memory and the computer program code are configured, with the at least one processor, to cause the apparatus at least to
send a message indicating overload to a network entity, wherein the message comprises a back-off time value to indicate the overload; and
selectively reduce signaling based on the message.

9. The apparatus according to claim 8, wherein the back-off time value is indicated as being applicable to a single access point name (APN) or is a nodal back-off time applicable to all access point names (APNs).

10. The apparatus according to claim 8, wherein the message is a create session response message comprising a cause information element (IE) or scope information element (IE) along with the back-off time value.

11. The apparatus according to claim 10, wherein the cause information element (IE) or the scope information element (IE) comprises an indication of selective reduction in signaling.

12. The apparatus according to claim 11, wherein the indication of selective reduction in signaling comprises an access point name (APN) specific back-off selective signaling and/or a nodal overload selective signaling.

13. The apparatus according to claim 8, wherein, when the back-off time included in the message is indicated as being applicable to a single access point name (APN), the selectively reducing further comprises selectively reducing signaling for the specific access point name (APN) indicated in the message.

14. The apparatus according to claim 8, wherein, when the back-off time included in the message is a nodal back-off time, the selectively reducing further comprises selectively reducing signaling for the whole node.

15. The apparatus according to claim 8, wherein the apparatus comprises a gateway.

16. A computer program, embodied on a computer readable medium, the computer program configured to control a processor to perform a method according to claim 1.

17. A method, comprising:
receiving a message indicating overload at a network entity, wherein the message comprises a back-off time value to indicate the overload; and
selectively reducing signaling based on the message.

18. The method according to claim 17, wherein the back-off time value is indicated as being applicable to a single access point name (APN) or is a nodal back-off time applicable to all access point names (APNs).

19. The method according to claim 17, wherein the message is a create session response message comprising a cause information element (IE) or scope information element (IE) along with the back-off time value.

20. The method according to claim 19, wherein the cause information element (IE) or the scope information element (IE) comprises an indication of selective reduction in signaling.

21. The method according to claim 20, wherein the indication of selective reduction in signaling comprises an access point name (APN) specific back-off selective signaling and/or a nodal overload selective signaling.

22. The method according to claim 17, wherein, when the back-off time included in the message is indicated as being applicable to a single access point name (APN), the selectively reducing further comprises selectively reducing signaling for the specific access point name (APN) indicated in the message.

23. The method according to claim 17, wherein, when the back-off time included in the message is a nodal back-off time, the selectively reducing further comprises selectively reducing signaling for the whole node.

24. An apparatus, comprising:
at least one processor; and
at least one memory including computer program code,
wherein the at least one memory and the computer program code are configured, with the at least one processor, to cause the apparatus at least to
receive a message indicating overload at a network entity, wherein the message comprises a back-off time value to indicate the overload; and
selectively reduce signaling based on the message.

25. The apparatus according to claim 24, wherein the back-off time value is indicated as being applicable to a single access point name (APN) or is a nodal back-off time applicable to all access point names (APNs).

26. The apparatus according to claim 24, wherein the message is a create session response message comprising a cause information element (IE) or scope information element (IE) along with the back-off time value.

27. The apparatus according to claim 26, wherein the cause information element (IE) or the scope information element (IE) comprises an indication of selective reduction in signaling.

28. The apparatus according to claim 27, wherein the indication of selective reduction in signaling comprises an access point name (APN) specific back-off selective signaling and/or a nodal overload selective signaling.

29. The apparatus according to claim 24, wherein, when the back-off time included in the message is indicated as being applicable to a single access point name (APN), the selectively reducing further comprises selectively reducing signaling for the specific access point name (APN) indicated in the message.

30. The apparatus according to claim 24, wherein, when the back-off time included in the message is a nodal back-off time, the selectively reducing further comprises selectively reducing signaling for the whole node.

31. A computer program, embodied on a computer readable medium, the computer program configured to control a processor to perform a method according to claim 17.
